(19) United States
(12) Patent Application Publication
(10) Pub. No.: US 2013/0321758 A1
(43) Pub. Date: Dec. 5, 2013

(54) APPARATUS AND METHOD FOR SIMULTANEOUSLY REDUCING GLARE AND VIEWING A LIQUID CRYSTAL DISPLAY

(71) Applicant: Edward Collett, Long Branch, NJ (US)

(72) Inventor: Edward Collett, Long Branch, NJ (US)

(21) Appl. No.: 13/739,036

(22) Filed: Jan. 11, 2013

Related U.S. Application Data
(60) Provisional application No. 61/689,071, filed on May 29, 2012.

(51) Int. Cl. G02C 7/12

(52) U.S. Cl. CPC G02C 7/12
USPC 351/49

(57) ABSTRACT

Embodiments are described that simultaneously block glare arising from the reflection of polarized sunlight and can also allow a polarized liquid crystal display (LCD) to be clearly viewed. Embodiments may be useful for use as polarized sunglasses. Embodiments operate by using a unique property of a circular polarizer. One side of the circular polarizer substantially blocks the transmission of incident polarized light whereas the other side allows substantially complete transmission of incident polarized light. Using these opposite behaviors, polarizing sunglasses can be constructed in which the top portion uses a first side of the circular polarizer to block the polarized glare and the lower portion uses a second side of the circular polarizer, opposite from the first side, to view the LCD. Because two different polarizers are used, these sunglasses are called dual-polarization sunglasses to differentiate them from the traditional linear polarizer sunglasses

### CROSS-REFERENCE TO RELATED APPLICATIONS

This application claims the benefit of U.S. Provisional Patent Application Ser. No. 61/686,071, filed on May 29, 2012, the entire content of which is hereby incorporated by reference in its entirety.

### BACKGROUND

1. Field of the Invention

This invention relates to polarized sunglasses that can be used to simultaneously block the glare arising from unpolarized sunlight reflected from a planar surface, while allowing for the reading of liquid crystal displays (LCDs) without the need for substantial movement of the polarized sunglasses.

2. Description of Related Art

Polarized sunglasses have been available for many years, in which polarized lenses have been used to filter out undesirable reflections, e.g., glare, and to reduce eye strain and fatigue. In addition, because polarizing sunglasses are tinted or appear to be tinted, the transmitted intensity is reduced, thereby allowing further reduction in eye fatigue. The use of linear polarizing glasses has until recently been satisfactory for use in most environments.

Polarized sunglasses are widely used by automobile drivers to reduce the glare from road reflections and atmospheric scattering (e.g., sky polarization). Commercial polarized sunglasses are linear vertical polarizers that take advantage of the Brewster reflection angle. Unpolarized light from the sun contains electromagnetic (“EM”) field components at substantially all orientation angles relative to the direction of propagation. Upon reflection of unpolarized light from a planar reflection surface at the Brewster angle, the component perpendicular to the plane of the reflection surface vanishes and only the component parallel to the plane of the reflection surface remains. Polarized sunglasses are constructed using linear vertical polarizers to view the reflected light with the result that the perpendicular component of the reflected light is blocked by the linear vertical polarizer and the intensity of the glare is dramatically reduced

However, liquid crystal displays (LCDs) are a new type of display that has appeared in recent years and are now ubiquitous. For example, automobile dashboards have evolved from using a single, relatively simple dashboard display to using numerous LCD displays that provide information to the driver such as time, tuning station for the radio, CD player, etc. This transformation to the usage of numerous displays has been highly criticized by regulatory automobile organizations. The National Highway Traffic Safety Administration has criticized the increasing number of so-called dash-apps. Their sheer number has become overwhelming and has led to distractions and reduced driving safety. Indeed, N.H.T.S.A. even regards navigation as interfering inherently with a driver's ability to safely control the vehicle. The agency points out that 17 percent, or nearly 900,000, of police-reported accidents in the United States in 2010 were because of driver distraction. Among their recommendations is that any in-dash operation which requires the driver to look away from the road for more than two seconds be disabled because of the distance traveled. In two seconds a vehicle moving at a speed of 60 mph travels a distance of 176 feet.

Often a linear polarizer is incorporated into the design of an LCD display, which causes light emitted from the LCD display to be linearly polarized, [usually] linear +45° polarized (L+45P). If the driver views the display while he or she is driving, the LCD display may be blocked by the linear polarized sunglasses and artifacts such as dark patches may appear on the display. In order to view the LCD display, many drivers may lift their polarized sunglasses so that the polarized sunglasses are not in their line of sight to the LCD display. The result is that for several seconds when driving in a glare environment, the driver is distracted from viewing the road, which exacerbates the dangerous and life threatening conditions noted by the N.H.T.S.A.

One solution to this problem has been to divide the sunglass lens so that the upper portion of the lens is linearly polarized and blocks glare, whereas the lower portion of the lens is left unpolarized. A drawback of this solution is that for comfortable viewing, the tint and the optical transmission of the lower part of the sunglass using a non polarizing material must be substantially identical to the tint and transmission in the upper polarizing element.

Therefore, a need exists to provide sunglasses that simultaneously reduce glare and allow an LCD display to be viewed, with substantially identical tint and transmission properties throughout the lens in order to provide a comfortable and safer driving environment.

### SUMMARY

Drawbacks of the related art may be addressed using the properties of circular polarizers. Circular polarizers are known in the art as being constructed from a birefringent material having a fast axis and a slow axis, and the thickness of the birefringent material selected such that the phase of an electromagnetic field aligned with the slow axis is retarded by a quarter-wavelength compared to the phase of an electromagnetic field aligned with the fast axis, when both electromagnetic fields pass through the circular polarizer. For this reason, the circular polarizer may also be referred to as a quarter-wave plate (“QWP”). For wavelengths of visible light, approximately 450 nm to approximately 750 nm, the variation in wavelength is relatively negligible and a QWP of a single thickness is adequate for all visible light in accordance with embodiments of the present invention.

Embodiments in accordance with the present invention provide circular polarizers that are constructed using a combination of two polarizing elements that are joined together: (1) a linear polarizer; and (2) a quarter-waveplate. Light entering the linear polarizer side of the combination emerges as circular polarized light. Light entering the quarter-waveplate side of the combination emerges as linear polarized light. Embodiments in accordance with the present invention provide a polarized sunglass in which the upper portion of the sunglass blocks the glare white the lower portion allows a driver to view an LCD display. This configuration is also referred to herein as a dual-polarized sunglass. The dual-polarized sunglass will allow the driver to wear sunglasses as usual while driving, and simultaneously view the LCD display without removing the sunglasses or otherwise moving the sunglasses relative to the face, by merely moving his or her eyes and/or shifting his or her head, such that a line of sight in a first direction to the road passes through the upper polarizer, and a line of sight in a second direction to the LCD display passes through the lower polarizer.

Embodiments in accordance with the present invention are also usable with displays that emit circularly polarized light, even though such displays may also be adequately usable with conventional sunglasses.

The preceding is a simplified summary of embodiments of the disclosure to provide an understanding of some aspects of the disclosure. This summary is neither an extensive nor an exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates a cross-sectional view of a portion of a polarized lens for a first incident light, in accordance with an embodiment of the present invention;

FIG. 2 illustrates polarization properties when an unpolarized light reflects from a surface;

FIG. 3 illustrates a cross-sectional view of a portion of a polarized lens for a polarized incident light, in accordance with an embodiment of the present invention;

FIG. 4 illustrates a schematic view of sunglasses in accordance with an embodiment of the present invention;

FIG. 5 illustrates a schematic view of a lens in accordance with an embodiment of the present invention;

FIG. 6A illustrates a cross-sectional view of a polarized lens in accordance with an embodiment of the present invention;

FIG. 6B illustrates a cross-sectional view of a polarized lens in accordance with an embodiment of the present invention; and

FIG. 7 illustrates a perspective view of sunglasses in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

In the following detailed description, numerous specific details are set forth in order to provide a thorough understanding of embodiments or other examples described herein. In some instances, well-known methods, procedures and components have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

Embodiments in accordance with the present invention disclose a dual-polarized sunglass, which is a new type of sunglass that can overcome both polarization from reflected sunlight (i.e., glare) and is compatible with the linear polarized light emitted by LCD displays. The sunglass may be fitted in a frame, either as one lens covering both eyes or separate lenses for each eye. The frame may be fitted to a wearer's head, for example as conventional glasses or sunglasses, or as a helmet-mounted visor, or the like.

Mathematical Background

In order to describe operation of a circular polarizer, a 4×4 Mueller matrix formulation and Stokes vector parameters are used. The 4×4 Mueller matrix describes a transformation caused by a polarizing element and the Stokes vector describes the polarization state of an optical beam.

Conventional circular polarizers are constructed using a linear horizontal polarizer with its transmission axis rotated through +45° from the x axis followed by a quarter-waveplate with its fast axis along the horizontal x axis and its slow axis along the y axis. The respective Mueller matrices of the two elements having the form shown in Equations (1) and (2).

$$\begin{matrix}{M}_{QWP} = [ \begin{matrix}1 & 0 & 0 & 0 \\ 0 & 1 & 0 & 0 \\ 0 & 0 & 0 & - 1 \\ 0 & 0 & 1 & 0\end{matrix} ] & ( 1 ) \\ {M}_{L + 45 P} = \frac{1}{2} [ \begin{matrix}1 & 0 & 1 & 0 \\ 0 & 0 & 0 & 0 \\ 1 & 0 & 1 & 0 \\ 0 & 0 & 0 & 0\end{matrix} ] & ( 2 )\end{matrix}$$

The incident light is described by a Stokes vector S having the general form shown in Equation (3).

$$S = ( \begin{matrix}{S}_{0} \\ {S}_{1} \\ {S}_{2} \\ {S}_{3}\end{matrix} ) \qquad ( 3 )$$

The first parameter S₀ describes the intensity of the optical beam and the three remaining parameters S₁, S₂, and S₃ describe the polarization state of the optical beam. The parameters S₁ and S₂ describe the linear polarization state and S₃ describes the circular polarization state. If all four parameters appear in Equation (3), the light is elliptical polarized.

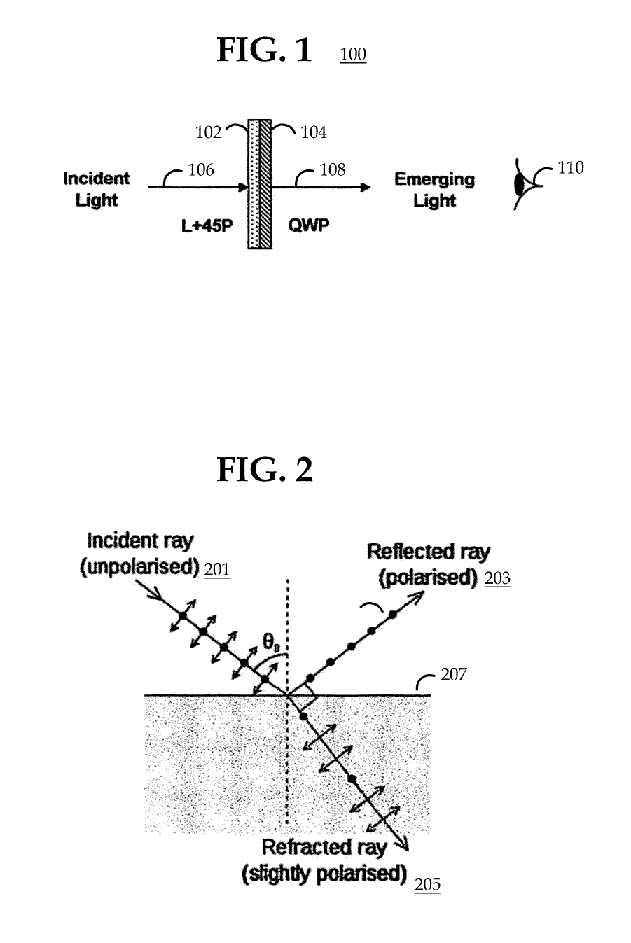

FIG. 1 illustrates a circular polarizer 100 created by joining together a linear polarizing element 102 with quarter waveplate element 104, such that the linear polarizing element 102 faces an incident light ray 106. The incident light ray 106, which may be either unpolarized light or be horizontally polarized road glare, is thereby transformed into an outgoing circularly polarized light ray 108, which then may be seen by observer 110 such as a driver, in accordance with an embodiment of the present invention. The Mueller matrix for circular polarizer 100 has the form shown in Equation (4).

$$\begin{matrix}{M}_{CP} = {M}_{QWP} \times {M}_{L + 45 P} \\ = \frac{1}{2} [ \begin{matrix}1 & 0 & 1 & 0 \\ 0 & 0 & 0 & 0 \\ 0 & 0 & 0 & 0 \\ 1 & 0 & 1 & 0\end{matrix} ]\end{matrix} \qquad ( 4 )$$

Equation (4) describes a circular polarizer as indicated by the subscript “CP”. For an incident beam represented by the Stokes vector S as shown in Equation (3), the Stokes vector S_{OBS} of the observed emerging beam 108 shown in FIG. 1 using Equations (3) and (4) is

$$\begin{matrix}{S}_{OBS} = {M}_{CP} \times S \\ = \frac{1}{2} [ \begin{matrix}1 & 0 & 1 & 0 \\ 0 & 0 & 0 & 0 \\ 0 & 0 & 0 & 0 \\ 1 & 0 & 1 & 0\end{matrix} ] \times [ \begin{matrix}{S}_{0} \\ {S}_{1} \\ {S}_{2} \\ {S}_{3}\end{matrix} ] \\ = \frac{{S}_{0} + {S}_{2}}{2} [ \begin{matrix}1 \\ 0 \\ 0 \\ 1\end{matrix} ]\end{matrix} \qquad ( 5 )$$

In Equation (5), S₁=S₂=0 and S₃=1. This result shows the light 108 that emerges from circular polarizer 100 and viewed by the observer 110 is right circular polarized. Thus, regardless of the polarization state of the incident beam the emerging beam 108 will always be right circular polarized.

Glare occurs when an incident unpolarized beam is reflected from a dielectric surface, such as the reflection of unpolarized sunlight from the surface of the road or water. Atmospheric scattering may also produce glare. While driving, glare is often observed in reflections close to or at the Brewster angle of incidence. This is shown by FIG. 2, in which an incident unpolarized ray 201 impinges surface 207. Surface 207 is ordinarily a dielectric surface 207 (e.g., asphalt, water, oil, etc.). Unpolarized ray 201 is shown having both a vertical polarization component (denoted by double-headed arrows on unpolarized ray 201, indicating vectors parallel to the plane of FIG. 2) and a horizontal polarization component (denoted by dots on unpolarized ray 201, indicating vectors perpendicular to the plane of FIG. 2).

Upon impinging dielectric surface 207, unpolarized ray 201 is split into a polarized reflected ray 203 and/or a slightly polarized refracted ray 205. Ray 205 is illustrated as having a greater vertical polarization component than horizontal polarization component. At the Brewster angle, only the horizontal polarization component (denoted by dots) remains, so the reflected light ray 203 is linear horizontal polarized (LHP). The reflected light ray 203 may also be referred to herein as glare or a glare beam.

The Stokes vector for the glare beam is linear horizontally polarized having the form shown in Equation (6).

$${S}_{GLARE} = ( \begin{matrix}1 \\ 1 \\ 0 \\ 0\end{matrix} ) \qquad ( 6 )$$

Used directly, the conventional circular polarizer 100 will not remove the glare in the configuration of FIG. 1 without appropriate selection of an orientation angle. The glare can be removed by rotating the configuration shown in FIG. 1 through an angle of +45°. Upon doing this Equation (4) is transformed to the form shown in Equation (7).

$${M}_{CPROT} = \frac{1}{2} [ \begin{matrix}1 & - 1 & 0 & 0 \\ 0 & 0 & 0 & 0 \\ 0 & 0 & 0 & 0 \\ 1 & - 1 & 0 & 0\end{matrix} ] \qquad ( 7 )$$

The Stokes vector of the reflected light that is now incident on the driver's eye is now found by matrix multiplying Equation (6) by Equation (7), to produce the form shown in Equation (8).

$${S}_{REFL} = {M}_{CPROT} \times {S}_{GLARE} = \frac{1}{2} [ \begin{matrix}1 & - 1 & 0 & 0 \\ 0 & 0 & 0 & 0 \\ 0 & 0 & 0 & 0 \\ 1 & - 1 & 0 & 0\end{matrix} ] \times [ \begin{matrix}1 \\ 1 \\ 0 \\ 0\end{matrix} ] = [ \begin{matrix}0 \\ 0 \\ 0 \\ 0\end{matrix} ] \qquad ( 8 )$$

Thus, the Stokes vector of the observed light is zero after passing through the rotated circular polarizer. Since the first element of the Stokes vector is the intensity of the observed light, and since the first element is zero, the rotated circular polarizer has blocked the glare.

We now consider light emitted by an LCD display. The polarization of the light emitted by most LCD displays is linearly −45° polarized (L−45P). The Stokes vector for L−45P light is of the form shown in Equation (9).

$${S}_{L - 45 P} = [ \begin{matrix}1 \\ 0 \\ - 1 \\ 0\end{matrix} ] \qquad ( 9 )$$

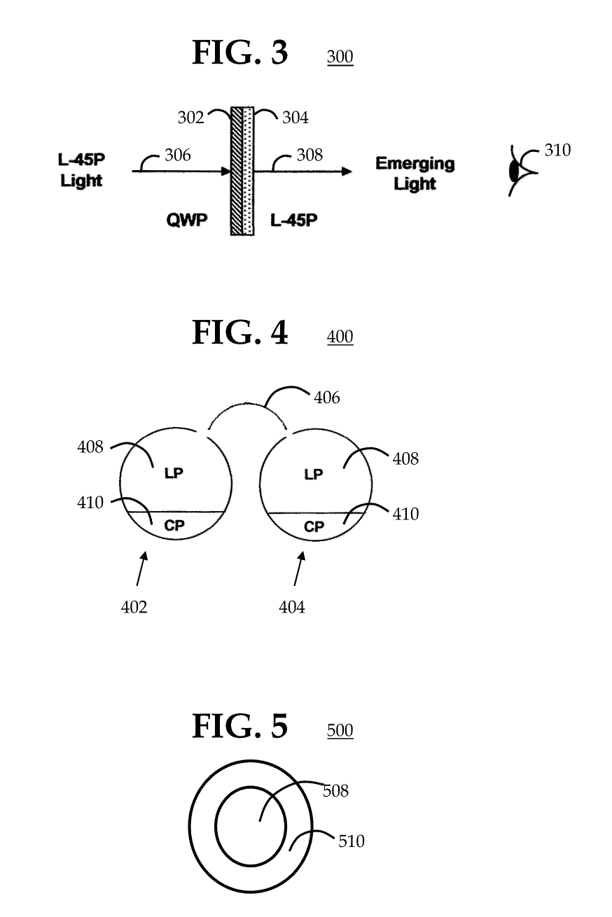

FIG. 3 illustrates an embodiment in accordance with the present invention when viewing light emitted by the LCD display. FIG. 3 illustrates a linear polarizer 300 created by joining together a quarter waveplate element 302 with a linear polarizing element 304, such that the circular polarizing element 302 faces an incident light ray 306. The incident light ray 306, which may be either unpolarized light or be light emitted by an LCD display, is thereby transformed into an outgoing linearly polarized light ray 308, which then may be seen by observer 310 such as a driver wearing sunglasses in accordance with an embodiment of the present invention. The Mueller matrix for linear polarizer 300 has the form shown in Equation (10).

$${M}_{LP} = {M}_{L - 45 P} \times {M}_{QWP} = \frac{1}{2} [ \begin{matrix}1 & 0 & 0 & 1 \\ 0 & 0 & 0 & 0 \\ - 1 & 0 & 0 & - 1 \\ 0 & 0 & 0 & 0\end{matrix} ] \qquad ( 10 )$$

In general, the configuration shown in FIG. 3 may be rotated through an angle θ. The angle θ may represent an offset in the coordinate frame of reference between that of the LCD display and that of sunglasses in accordance with an embodiment of the present invention. The rotation may arise if, for example, a mobile device with an LCD display is placed by the user at certain positions or angles, of if the mobile device moves as a result of vehicle motion, or if the user tilts their head in certain axes of rotation while looking at the LCD display, and so forth. The rotation operation transforms the Muller matrix to a matrix having the form shown in Equation (11).

$${M}_{LPROT} = \frac{1}{2} [ \begin{matrix}1 & 0 & 0 & 1 \\ sin 2 θ & 0 & 0 & sin 2 θ \\ - cos 2 θ & 0 & 0 & - cos 2 θ \\ 0 & 0 & 0 & 0\end{matrix} ] \qquad ( 11 )$$

The L−45P light emitted by the LCD display is now observed by observer 310 and is described by a Stokes vector formed by multiplying the Muller matrix of Equation (11) by the Stokes vector for L−45P light as shown in Equation (9), to produce a Stokes vector having the form shown in Equation (12).

$${S}_{OBS} = {M}_{LPROT} \times {S}_{L - 45 P} = \frac{1}{2} [ \begin{matrix}1 & 0 & 0 & 1 \\ sin 2 θ & 0 & 0 & sin 2 θ \\ - cos 2 θ & 0 & 0 & - 2 cos θ \\ 0 & 0 & 0 & 0\end{matrix} ] \times [ \begin{matrix}1 \\ 0 \\ - 1 \\ 0\end{matrix} ] = [ \begin{matrix}1 \\ sin 2 θ \\ - cos 2 θ \\ 0\end{matrix} ] \qquad ( 12 )$$

S_{OBS} of Equation (12) represents the Stokes vector, observed by a driver, of the light emitted by an LCD display and passing through the polarizer of FIG. 3 rotated by θ degrees, in accordance with an embodiment of the present invention. Equation (12) shows that regardless of the rotation angle of polarizer 300 with respect to the LCD display, the intensity of the light seen by driver 310 (as evidenced by the first element of the S_{OBS} vector) does not vary with rotation angle. This characteristic is also true regardless of the orientation angle of the linear polarized light emitted by the LCD display. This is readily shown by representing the polarization state emitted by the LCD display as having the form shown in Equation (13).

$${S}_{LCD} = [ \begin{matrix}{S}_{0} \\ {S}_{1} \\ {S}_{2} \\ {S}_{3}\end{matrix} ] \qquad ( 13 )$$

Multiplying the Muller matrix of Equation (11) by the Stokes vector of Equation (13) yields a Stokes vector having the form shown in Equation (14).

$${S}_{OBS} = {M}_{LPROT} \times {S}_{LCD} = \frac{1}{2} [ \begin{matrix}1 & 0 & 0 & 1 \\ sin 2 θ & 0 & 0 & sin 2 θ \\ - cos 2 θ & 0 & 0 & - 2 cos θ \\ 0 & 0 & 0 & 0\end{matrix} ] \times [ \begin{matrix}{S}_{0} \\ {S}_{1} \\ {S}_{2} \\ {S}_{3}\end{matrix} ] = \frac{{S}_{0} + {S}_{3}}{2} [ \begin{matrix}1 \\ sin 2 θ \\ - cos 2 θ \\ 0\end{matrix} ] \qquad ( 14 )$$

Thus, Equation (14) shows that regardless of the orientation of the linear polarized light emitted by the LCD display, the intensity seen by the driver will always be constant, as evidenced by the first element of the S_{OBS} vector.

This result is in contrast to the behavior seen by viewing the LCD display through a rotated linear polarizer not having the structure of linear polarizer 300, i.e., without being joined to quarter waveplate 302. The Mueller matrix for a rotated linear polarizer is of the form shown in Equation (15).

$${M}_{POLROT} = \frac{1}{2} [ \begin{matrix}1 & cos 2 θ & sin 2 θ & 0 \\ cos 2 θ & {cos}^{2} 2 θ & cos 2 θsin 2 θ & 0 \\ - sin 2 θ & cos 2 θsin 2 θ & {sin}^{2} 2 θ & 0 \\ 0 & 0 & 0 & 0\end{matrix} ] \qquad ( 15 )$$

Multiplying the Muller matrix of Equation (15) by an arbitrary Stokes vector of light emitted by the LCD display, as given in Equation (13), produces a Stokes vector having the form shown in Equation (16).

$${S}_{OBS} = \frac{1}{2} [ \begin{matrix}{S}_{0} + {S}_{1} cos 2 θ + {S}_{2} sin 2 θ \\ {S}_{0} cos 2 θ + {S}_{1} {cos}^{2} 2 θ + {S}_{2} sin 2 θcos 2 θ \\ {S}_{0} sin 2 θ + {S}_{1} cos 2 θsin 2 θ + {S}_{2} {sin}^{2} 2 θ \\ 0 \end{matrix} ] \qquad ( 16 )$$

Equation (16) shows that the intensity as viewed by an observer, i.e., the first element of the S_{OBS} vector, is of the form shown in Equation (17).

$$I ( θ ) = \frac{1}{2} ( {S}_{0} + {S}_{1} cos 2 θ + {S}_{2} sin 2 θ ) \qquad ( 17 )$$

Thus, as the alignment between an LCD display and a conventional linear polarizer changes, e.g., if the LCD display is moved or if an observer rotates their head with respect to the LCD display, the intensity will vary if conventional linearly polarized sunglasses are used. This accounts for unexpected visual artifacts when a user views an LCD display through conventional linearly polarized sunglasses.

The visual artifacts may be exacerbated because linear polarizers are often fabricated from polyvinyl alcohol polymers that are doped with iodine. The polyvinyl alcohol polymers are arranged as strands, and the iodine atoms bond to the strands in order to polarize the light passing through. Because iodine is a very large atom, its outermost atomic shell contains seven electrons that are held very loosely. This allows the incident radiation to excite the electrons which then re-emit the incident radiation perpendicular to the strands. There is also a certain amount of dichroism in the polarizers and iodine naturally dyes the polyvinyl so the result is that, e.g., Polaroids and commercial polarizers have a reddish-purple tint.

Certain less common LCD displays may emit light that is either right or left circular polarized. In this condition, the incident beam from the LCD display is represented by the Stokes vector given by Equation (3) and the Mueller matrix for the rotated right circular polarizer has the form shown in Equation (18).

$${M}_{RCPROT} = \frac{1}{2} ( \begin{matrix}1 & - sin 2 θ & cos 2 θ & 0 \\ 0 & 0 & 0 & 0 \\ 0 & 0 & 0 & 0 \\ 1 & - sin 2 θ & cos 2 θ & 0\end{matrix} ) \qquad ( 18 )$$

The Stokes vector of the beam incident on the eye is then found by matrix multiplying Equation (18) with Equation (3), to have the form shown in Equation (19).

$${S}_{EYE} = \frac{1}{2} ( \begin{matrix}{S}_{0} - {S}_{1} sin 2 θ + {S}_{2} cos 2 θ \\ 0 \\ 0 \\ {S}_{0} - {S}_{1} sin 2 θ + {S}_{2} cos 2 θ\end{matrix} ) = \frac{{S}_{0} - {S}_{1} sin 2 θ + {S}_{2} cos 2 θ}{2} ( \begin{matrix}1 \\ 0 \\ 0 \\ 1\end{matrix} ) \qquad ( 19 )$$

Thus, the light incident on the eye is right circularly polarized and the intensity of light on the eye has the form shown in Equation (20).

$${I}_{EYE} = \frac{1}{2} ( {S}_{0} - {S}_{1} sin 2 θ + {S}_{2} cos 2 θ ) \qquad ( 20 )$$

For either right or left circular polarized light emitted by the circularly polarized LCD display, S₁=S₂=0 so Equation (20) reduces to have the form shown in Equation (21).

$${I}_{EYE} = \frac{{S}_{0}}{2} \qquad ( 21 )$$

Equation (21) shows the intensity is constant and is invariant of rotation. Accordingly, dual-polarized sunglass for LCD displays emitting right or left circular polarized light will include a vertically oriented polarizer 100 to block the glare, together with a circular polarizer mounted on the bottom. It is not necessary for the circular polarizer to be flipped and the emphasis must be made that this configuration is only applicable to the emission of right or left circularly polarized light. Analysis shows that both linear and circular polarized displays can be seen through the circular polarized portion of the sunglasses.

Thus, the foregoing mathematical analysis shows that an embodiment in accordance with the present invention, which combines the structure of FIG. 1 and FIG. 3, may be used to eliminate the glare and view a LCD display simultaneously.

A driver wearing sunglasses in accordance with an embodiment of the present invention may view the road through the structure of FIG. 1 in order to eliminate glare, while viewing an LCD display at substantially any angle through the structure of FIG. 3 in order to eliminate artifacts observed when the linearly polarized light emitted by an LCD display passes through a conventional linear polarizer.

Application of the Mathematical Background

Lenses for dual-polarized sunglasses in accordance with an embodiment of the present invention may be prepared from a single sheet of a circular polarizer, appropriately cut in accordance with the diagrams of FIG. 1 and FIG. 3. The linear polarizing side of polarizer 100 is oriented toward a source of glare, and may be used in the upper part of a dual-polarized sunglass lens in order to block the glare. The circular polarizing side of the polarizer 300 is oriented toward an LCD display, and may be used in the lower part of a dual-polarized sunglass lens in accordance with an embodiment of the present invention. Using the same sheet the circular polarizer tends to lessen intensity variations between polarizer 100 and polarizer 300. The linear and circular elements are fused seamlessly to form embodiments in accordance with the present invention.

FIG. 4 illustrates a schematic view of sunglasses 400 in accordance with an embodiment of the present invention. Sunglasses 400 are illustrated from a point of view as seen by light propagating toward sunglasses 400, i.e., as if by seen by an outside observer on the face of a person wearing sunglasses 400. Sunglasses 400 are illustrated as including a first lens 402 covering a first eye and a substantially similar second lens 404 covering a second eye, which may be connected by a bridge piece 406, either directly or by coupling to a frame supporting the first lens 402 and/or second lens 404. It should be understood that other physical embodiments are possible, such as a single lens that covers both eyes and presents substantially the same optical characteristics to both eyes (such as a visor or helmet), or as clip-ons that clip individually or together to a conventional pair of eyeglasses, and so forth. Bridge piece 406 may be omitted if first lens 402 and second lens 404 are independently secured, such as by individual clip-ons to a conventional pair of eyeglasses. In another, more durable embodiment, first lens 402 and second lens 404 may be coupled to one or more relatively thin plates or layers of shatter-resistant light-transmissive material (e.g., glass, resin, plastic, etc.) so as to make dual-polarized sunglasses. The plates or layers may be provided between first lens 402 and second lens 404, or outside the combination of the first lens 402 and second lens 404.

Another embodiment may be to make optical quality eyeglasses (e.g., prescription sunglasses) and impregnating the linear and circular materials, e.g., liquid crystals into a transmissive substrate material such as glass, plastic, resin, or the like. Another embodiment may be to provide first lens 402 and second lens 404 as contact lenses.

Lenses 402 and 404 each include a first region 408 and a second region 410. First region 408 includes a polarized material in accordance with FIG. 1. Second region 410 includes a polarized material in accordance with FIG. 3. The relative sizes and positions of first region 408 and second region 410 may be chosen such that a roadway in front of a driver ordinarily will be seen while looking through first region 408, and a dashboard and other interior portions of a vehicle below the dashboard ordinarily will be seen while looking through second region 410, when embodiments of the present invention are worn in a typical manner by a driver or front-seat passenger of a vehicle.

Although sunglasses 400 are illustrated as having particular shapes for first region 408 and second region 410, regions 408 and 410 may have substantially any shape such that an upper portion of lenses 402 and 404 include first region 408 and a lower portion of lenses 402 and 404 include second region 410.

Another embodiments in accordance with the present invention may be to fabricate lens 402 or 404 as a contact lens, but weighted such that second region 410 is relatively heavier, so that the contact lens will tend to seek the correct orientation when placed on a user's cornea.

Additional, non-polarization specific additives may be added to any of the layers or regions discussed above, or added as a separate layer, in order to provide additional light blockage by the sunglasses, or a desired color (e.g., gray, green, yellow, etc.), effect (e.g., mirrored, gradient, scratch resistance, lettering on the lenses, etc.), and so forth.

FIG. 5 illustrates a schematic view of an embodiment of a contact lens 500 in accordance with the present invention. Contact lens 500 may be fabricated as substantially concentric regions, such that an inner region 508 is fabricated in accordance with FIG. 1 and an outer region is fabricated in accordance with FIG. 3. The relative sizes and positions of first region 508 and second region 510 may be chosen such that a roadway ordinarily will be seen by the fovea of a driver while looking through first region 508, and a dashboard and other interior portions of a vehicle below the dashboard ordinarily will be seen while looking through second region 510, when embodiments of the present invention are worn in a typical manner by a driver or front-seat passenger of a vehicle. Contact lens 500 does not need to have a weighted side since the design is rotationally invariant.

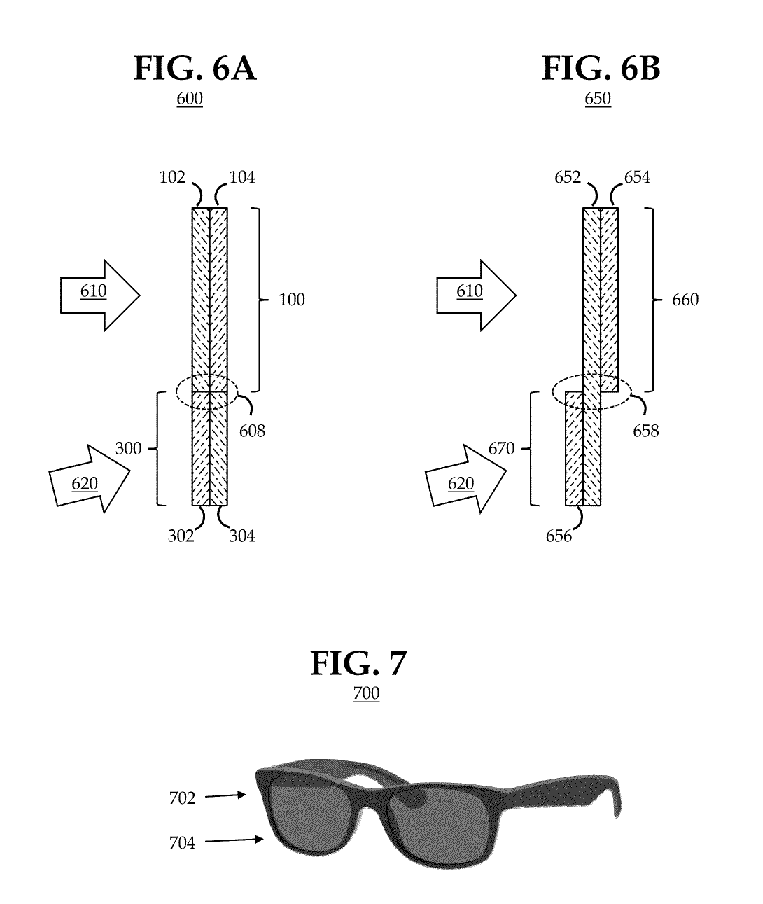

FIG. 6A illustrates a cross-sectional view of an embodiment of a lens 600 in accordance with the present invention. Lens 600 includes a first polarizer 100 as shown in FIG. 1, and a second polarizer 300 as shown in FIG. 3. Glare 610 and light 620 from an LCD display impinge lens 600 from the left as shown. Glare 610 and light 620 generally arrive to the user from different viewing angles or lines of sight. As illustrated, first polarizer 100 and second polarizer 300 have substantially the same width. A transition region 608 may be provided, such as by fusing, in order to lessen physical or optical discontinuities arising from joining first polarizer 100 and second polarizer 300.

FIG. 6B illustrates a cross-sectional view of an embodiment of a lens 650 in accordance with the present invention. Lens 650 includes a layer 652 functioning as a substrate for both first polarizer 660 and second polarizer 670. First polarizer 660 generally corresponds to first polarizer 100 of FIG. 1, and second polarizer 670 generally corresponds to first polarizer 300 of FIG. 3. Layer 652 is constructed from a material having a first polarization property, and ordinarily functions as a circular polarizer. Layer 654 is constructed from a material having a second polarization property, and ordinarily functions as a linear polarizer such as L+45P or L−45P. Layer 656 is constructed from a material having a polarization property different than the first polarization property, and ordinarily functions as a linear polarizer such as L−45P or L+45P. A transition region 658 may be provided to lessen physical or optical discontinuities arising from joining first polarizer 660 and second polarizer 670. Lens 650 may be fabricated by applying layer 654 and/or layer 656 as a film or coating over the respective side of substrate layer 652.

It is aesthetically preferable that first and second polarized regions (e.g., polarizers 100 and 300, polarizers 660 and 670, etc.) have similar darkness (i.e., optical transmission attenuation), tint, and thickness, and minimal physical discontinuity, so that the difference between polarized regions is not readily apparent except in the presence of polarized light. However, this does not preclude intentional application of effects such as a tinting-based darkness gradient.

Additional layers or coatings may be applied to lens 600 and/or lens 650 for other purposes, such as to provide strength, shatter resistance, scratch resistance, UV protection, and so forth. Although lens 600 and/or lens 650 are illustrated as planar, in a plane perpendicular to the plane of FIGS. 6A and 6B, it will be understood that lens 600 and/or lens 650 may be curved in order to provide a shape that is more contoured to the human face and/or head, or to provide certain embodiments such as a helmet-mounted visor. Normally, front and back major surfaces of lens 600 and 650, if curved, will be curved away from the expected location of the light source.

FIG. 7 illustrates a perspective view of a pair of sunglasses 700 with two lenses, with each lens having an upper portion 702 corresponding to region 408 of FIG. 4, and a lower portion 704 corresponding to region 410 of FIG. 4, in accordance with an embodiment of the present invention. A contrast in darkness or transmission intensity between upper portion 702 and lower portion 704 has been intentionally overemphasized in order to better illustrate the relative positions of portions of 702 and 704. Embodiments in accordance with the present invention preferably may have substantially uniform darkness or transmission intensity throughout substantially the entirety of each lens of sunglasses 700.

In another embodiment, a lower portion of the lens may be more light transmissive, so that it is easier for the wearer to read an LCD display through the lower portion while the wearer is in a car that is darker inside the car compared to outside the car.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A sunglass lens, comprising:
a first lens region having a first polarization property, a first tint, and a first optical transmission attenuation; and
a second lens region having a second polarization property, a second tint, and a second optical transmission attenuation,
wherein the first tint is substantially equal to the second tint, and the first optical transmission attenuation is substantially equal to the second optical transmission attenuation.

2. The sunglass lens of claim 1, wherein the first lens region is configured to block horizontally polarized light.

3. The sunglass lens of claim 1, wherein the first lens region comprises:
a first layer comprising a linear polarizer, the first layer further comprising:
a first major surface configured to face a light source and a second major surface; and
a second layer comprising a quarter-wave plate, the second layer further comprising:
a first major surface coupled to the second major surface of the first layer; and
a second major surface configured to face an eye of a wearer of the sunglass lens.

4. The sunglass lens of claim 1, wherein the second lens region is configured to pass horizontally polarized light.

5. The sunglass lens of claim 1, wherein the second lens region is configured to pass L−45P horizontally polarized light.

6. The sunglass lens of claim 1, wherein the second lens region comprises:
a first layer comprising a quarter-wave plate, the first layer further comprising:
a first major surface configured to face a light source and a second major surface; and
a second layer comprising a linear polarizer, the second layer further comprising:
a first major surface coupled to the second major surface of the first layer; and
a second major surface configured to face an eye of a wearer of the sunglass lens.

7. The sunglass lens of claim 1, wherein the sunglass lens is configured such that light passing through the sunglass lens is visible to both eyes of a wearer of the sunglass lens.

8. The sunglass lens of claim 1, wherein at least one of the first and second layers comprise liquid crystals impregnated into a transmissive substrate material.

9. The sunglass lens of claim 1, wherein the first lens region comprises an upper portion of the sunglass lens and the second lens region comprises a lower portion of the sunglass lens.

10. The sunglass lens of claim 1, wherein the first lens region and the second lens region have substantially equal width.

11. The sunglass lens of claim 1, wherein the first lens region comprises a central portion of the sunglass lens and the second lens region comprises an encircling periphery portion of the sunglass lens.

12. The sunglass lens of claim 1, further comprising a fused transition region between the first lens region and the second lens region.

13. The sunglass lens of claim 1, further comprising:
a quarter-wave plate substrate having a first major surface facing a light source and a second major surface facing an eye of a wearer of the sunglass lens;
a first linear polarizer coupled to the first major surface to form the second lens region; and
a second linear polarizer coupled to the second major surface to form the first lens region.

14. An apparatus comprising:
a first sunglass lens;
a frame wearable by a wearer, the frame configured to position the first sunglass lens over at least a first eye,
wherein the first sunglass lens comprises:
a first lens region having a first polarization property, a first tint, and a first optical transmission attenuation; and
a second lens region having a second polarization property, a second tint, and a second optical transmission attenuation,
wherein:
the first tint is substantially equal to the second tint, and the first optical transmission attenuation is substantially equal to the second optical transmission attenuation:
the first lens region is configured to block horizontally polarized light; and
the second lens region is configured to pass horizontally polarized light.

15. The apparatus of claim 14, wherein the frame comprises an eyeglass frame.

16. The apparatus of claim 14, wherein the frame comprises a helmet.

17. The apparatus of claim 14, wherein the frame is configured to position the first sunglass lens over both the first eye and a second eye.

18. The apparatus of claim 14, further comprising a second sunglass lens substantially equivalent to the first sunglass lens, wherein the frame is further configured to position the second sunglass lens over a second eye.
